(19) United States
(12) Patent Application Publication
(10) Pub. No.: US 2022/0081334 A1
(43) Pub. Date: Mar. 17, 2022

(54) METHOD FOR THE REMOVAL OF AT LEAST ONE CONTAMINANT FROM AN AQUEOUS LIQUOR OR A GAS

(71) Applicant: SOLVAY SA, Brussels (BE)

(72) Inventors: Eric COUDRY, Crevic (FR); Sabrina BEDEL, Dombasle Sur Meurthe (FR); Perrine DAVOINE, Brussels (BE); Thierry DELPLANCHE, Mont-St-Guibert (FR)

(21) Appl. No.: 17/426,645

(22) PCT Filed: Feb. 20, 2020
(86) PCT No.: PCT/EP2020/054530

§ 371 Date: Jul. 29, 2021

(30) Foreign Application Priority Data
Feb. 22, 2019 (EP) 19158786.4

(51) Int. Cl. C02F 1/68; C02F 1/66; B01D 53/92; F01N 3/08; B01F 3/12; B01F 5/00; B01F 5/04

(52) U.S. Cl. CPC C02F 1/687; C02F 1/66; B01D 53/92; C02F 2101/101; B01F 3/1228; B01F 5/0062; B01F 5/043; F01N 3/085

(57) ABSTRACT

A method for the removal of at least one contaminant from an aqueous liquor or a gas, comprising: preparing a solution or slurry of a solid alkali reagent by supplying a solid alkali reagent into a pre-wetting chamber via a feed pipe; supplying a liquid via two or more liquid sidestreams, each through a liquid inlet positioned on a side wall of the chamber to allow the liquid sidestreams to wash an internal wall of a frusto-conical section of the chamber and flow, preferably tangentially onto the internal wall in a downward spiraling manner thereby forming a vortex, towards a fluid outlet of the chamber and to further wet the solid alkali reagent with the supplied liquid thereby forming a pre-wetted reagent; and flowing a stream though a conduit, thereby creating a suction by the eductor to draw the pre-wetted reagent out of the chamber fluid outlet and mixing it with the stream to form a slurry or solution; and directing the slurry or solution exiting the eductor to an aqueous liquor or gas treatment unit, removing at least a portion of the contaminant from the aqueous liquor or gas in the treatment unit.

### CROSS-REFERENCE TO RELATED APPLICATIONS

This application claims the priority of the patent application filed on Feb. 22, 2019 in Europe with Ser. No. 19/158,786.4, the whole content of this application being incorporated herein by reference for all purposes.

### TECHNICAL FIELD

The invention relates to a method for removing contaminants from an aqueous liquor or a gas, and more particularly to a method for removing contaminants such as sulphur dioxides (SOₓ), organics, non-metals and/or metals originating for instance from marine engine exhaust gases.

### BACKGROUND ART

Fossil fuels contain sulphur, which during combustion forms gaseous sulphur oxides, SOₓ. The amounts of SOₓ in fuel exhausts vary according to natural differences in the sulphur content of fuels. The dominant constituent, making up more than 95% of the SOₓ emission from combustion of fossil fuel, is sulphur dioxide, SO₂. SO₂ is a toxic gas, directly harmful for both fauna and flora. A secondary effect of SO₂ emission to the atmosphere is formation of sulphate aerosols and a third well recognized result of SO₂ emissions is acid rain. Ship emissions are regulated internationally by the IMO (International Maritime Organization) and must comply with the limits prescribed in revised Annex VI of MARPOL in January 2015 in particular. To meet existing and upcoming regulations on reduced sulphur oxide emissions, worldwide limits on the sulphur content of marine fuel are established. Marine fuel with a maximum sulphur content of 0.10% only is allowed in Sulphur Emission Control Areas started in 2015 and as of 2020, or alternatively as of 2025 depending on the availability of fuel, a 0.5% sulphur limit will apply worldwide.

However, there is limited availability of natural low sulphur fuels and the refinery process for desulphurization is costly and energy demanding. Additionally, fuels with the required low sulphur levels are significantly more expensive than those previously used. This serves as a great incentive to install pollution control devices for the removal of constituents from the exhaust gas after the combustion process and as a potential sustainable cheaper alternative to the use of low sulphur fuels in order to achieve the required emission limits. Exhaust gas after-treatment units called scrubbers can be utilized to reduce air pollutant emissions to an appropriate level. Certain Flue Gas Desulphurization (FGD) or scrubber techniques are being adapted from their usual land-based applications to marine applications. So-called exhaust gas scrubbers or just scrubbers seem promising for applications onboard ships.

A particular challenge for the adoption of land-based scrubbers to marine applications is the changing legislative requirements and also changing conditions when a ship sails through different waters such as in the established Emission Control Areas (ECA) with more strict SO₂ emission levels. From 2015, ships are not allowed to emit more SO₂ than corresponding to 0.1% sulphur in the fuel oil within emission controlled areas. Outside emission controlled areas, the limit is 3.5% sulphur until 2020 and 0.5% sulphur after 2020. Contrary to land-based installations, this means that a scrubber must be much more efficient when a ship enters an emission controlled area as well as that adjustments must be implemented to cope with changing seawater alkalinity (in case of a seawater scrubber), seawater temperature and engine load.

The cleaning effect in the exhaust gas scrubbers results from the fact that the combustion exhaust gases from the engine are passed through a purification medium. This can be seawater, fresh water or dry granules. The majority of the exhaust constituents is dissolved or reacts chemically with the ingredients of the water or the granules and is removed from the exhaust gas stream. The sulphur dioxide from the exhaust gas dissolves in water to form sulphurous acid (H₂SO₃). This sulphurous acid decomposes in solution into bisulphite/sulphite (HSO₃⁻/SO₃²⁻) and, if oxidation occurs, sulphates (HSO₄⁻/SO₄²⁻).

Scrubbers are divided according to two principles into wet and dry systems.

Wet scrubbers use ambient water (seawater) or water processed on board (fresh water) as cleaning media. Manufacturers use different construction systems for the scrubbing process. However, the principle is always the same: the exhaust gas is brought into contact with the water to initiate the cleaning process. The larger the surface of the water as a reaction surface, the more efficient the scrubbing process. The resulting wastewater is passed through a water purifier which eliminates the particles and partially oily residues.

In open systems, it is known technology to treat waste gases with seawater. The pH of surface seawater usually ranges from 8.1 to 8.9 and this natural alkalinity neutralizes absorbed sulphur dioxide. With absorption in seawater, the SO₂ will mainly end as bisulphite and sulphate in the water. Seawater is pumped directly into the purification levels. After the separation of oily solids the wastewater from the scrubbing process is diluted with seawater until it meets the adequate pH limits for wastewater discharges.

Closed systems use treated washwater which is run in a circuit independent of the ambient water. To keep the buffer capacity of the water constant, it is supplemented with an alkaline solution, usually sodium hydroxide (NaOH). The enrichment of the processing water with sodium hydroxide solution requires a 20° C.-60° C. tempered tank for NaOH and a monitoring unit that adds NaOH corresponding to the pH of the cleaning water

Hybrid systems combine the open and closed wet system. Seawater is used as washwater, which can be pumped directly into the sea in open mode. If necessary, it can be operated in closed mode with the addition of a buffering solution and without discharge of wastewater. The wastewater is collected in holding tanks and released in the port or into the open sea later on.

In open system, seawater is used and no neutralization chemicals, like NaOH, are required onboard the ship. The main disadvantages of an open system are that a very high water flow is required due to a limited seawater alkalinity and that seawater is relatively corrosive, whereby the costs of the scrubber construction material increases. Some operators of hybrid scrubbers use freshwater when they switch from open to closed loop; they reduce the seawater volume and supplement with freshwater, so the final loop contains a mixture of residual seawater and freshwater). Other operators continue using seawater and add the alkali additive when they switch from open to close loop however with less efficacy as if they were switching to freshwater in closed loop.

When running in closed-loop mode, up to now the supplemented alkaline additive has been in form of a solution generally a 50 wt % caustic soda solution which applies to both closed-loop and hybrid configurations. Sodium bicarbonate or carbonate solutions could be used too, however the solubility limit of these alkali additives is much less than NaOH. To keep a similar weight content in the liquid, the additive would be in slurry form which may lead to settling and handling issues. The alkali additive could be used in powder form instead of a concentration solution. Taken aboard dry and loaded into a silo, the powder can be mixed with fresh or desalinated water before entering the closed-loop circuit. One of the benefits in using a powder instead of a concentrated solution is the reduction of the risks involved when handling a very alkaline caustic soda and cost effectiveness since the powder additives are less expensive than the concentrated caustic soda solution yielding a reduction in operating costs that offsets the equipment investment.

However the dissolution of the alkaline powder does require freshwater, purified water, or cleaned water which is in short supply on board.

Using a solid alkali additive on a seaboard vessel instead of a concentrated alkali solution though necessitates the transfer of the dry alkaline material from a container or big bag to the scrubber and dispersing the dry alkaline material into the water to be treated.

Eductors have been used and are still used to transfer dry chemicals as a slurry, solution or solid. For example, liquid driven eductors have been used to slurry dry polymers and activated carbon in the water treatment industry and to transfer fly ash in the electric power industry. Also air, steam, and liquid driven eductors have been used for transfer of solids. However, problems are known to exist with eductor-based handling systems.

Liquid driven eductors can be used to transfer dry chemicals from a container, forming a solution or slurry of the chemical in the liquid carrier medium. Liquid driven eductors are known to be successfully used to prepare dilute solutions of polymer in water as well as to transfer insoluble materials, e.g., activated carbon, to storage as a slurry.

However, in tests using concentrated solutions of a solid alkali material like soda ash that is hydratable in water as the motive fluid to convey such solid or using water as the motive fluid to convey a solid hydratable alkali reagent (e.g., soda ash), the throat of the eductor or the eductor itself can rapidly get plugged with hydrates making frequent cleaning necessary.

Hence, there is still a need to develop a method for preparing a slurry or solution from a solid alkali reagent for treatment of an aqueous liquid or a gas to remove contaminants therefrom. Such method would be particularly useful for the removal of contaminants such as SOₓ, organics, non-metals and/or metals originating for instance from an exhaust gas effluent, preferably from marine engine exhaust gases carried out on board of a seaborne vessel.

### SUMMARY OF INVENTION

Accordingly, the present invention relates to a method for the removal of at least one contaminant from an aqueous liquor or a gas, comprising:
preparing a solution or slurry of a solid alkali reagent by, supplying a solid alkali reagent into a pre-wetting chamber via a solid feed pipe, preferably positioned at the top of this chamber;
supplying a liquid via two or more liquid sidestreams, each through a liquid inlet positioned on a side wall of the chamber to allow the liquid sidestreams to wash an internal wall of a frusto-conical section of the chamber and flow downward towards a fluid outlet of the chamber and to further wet the solid alkali reagent with the supplied liquid thereby forming a pre-wetted reagent, wherein the pre-wetted reagent exits the chamber via a fluid outlet which is connected to a conduit comprising an eductor;
flowing a stream though the conduit thereby creating a suction by the eductor to draw the pre-wetted reagent out of the solid feed pre-wetting chamber toward the chamber fluid outlet and mixing the pre-wetted reagent with the stream to form a slurry or solution of the alkali reagent exiting the eductor;

directing at least a portion of the slurry or solution of the alkali reagent exiting the eductor to an aqueous liquor or a gas treatment unit, preferably via a circulation loop in fluid communication with the treatment unit, and

removing at least a portion of the contaminant from the aqueous liquor or gas in the treatment unit.

In the method of the present invention, the contaminants can be SOₓ, organics, non-metals and/or metals. In the method of the present invention, the contaminant can originate from an exhaust gas, particularly originate from a marine engine exhaust gas. In the method of the present invention, the alkali reagent is used to remove at least a portion of the contaminants from the aqueous liquor or gas.

In a particular embodiment of the present invention, contaminants such as organics, non-metals and/or metals are removed from an aqueous liquor. In that case, the most preferred alkali reagent is a material comprising hydroxyapatite and/or brushite, most often comprising hydroxyapatite.

The aqueous liquor or gas is preferably treated in a treatment unit hydraulically connected to a circulation loop. The method for the removal of at least one contaminant advantageously comprises dispersing a solid alkali reagent using at least part of the aqueous liquor from the circulation loop to form a slurry or solution of the alkali reagent and then directing the slurry or solution of the alkali reagent to the treatment unit to remove at least a portion of the contaminants.

The process of the invention allows to inject a solution or slurry of sodium carbonate into a lithium carbonate production process from brine, as shown in FIG. 5. In that case, the alkali reagent is sodium carbonate, the aqueous liquor is a lithium chloride brine, the contaminant is magnesium and/or calcium, and the treatment unit is the complete process shown in FIG. 5.

These methods allow for the direct addition of alkali reagent solids into a circulation loop hydraulically connected to a treatment unit such as a wet scrubber or a slurry water treatment reactor (e.g., blanket sludge or fluidized bed reactor) without adding water such as fresh, cleaned or purified water.

A wet scrubber is a technique to clean exhaust gas, such as marine exhaust gas, and remove contaminating species such as SOₓ, organics, particulate matter, and/or metals. In the flue gas wet scrubber, the exhaust gas gets in close contact with fine water droplets in a co-current or counter-current flow. This method is effective when the water droplet size is rather small and the total surface area between gas and the washing water gets large. The washing water is normally recirculated in order to save freshwater and reduce the amount of wastewater generated by the wet scrubber.

An advantage of these methods for treatment of marine exhaust gas is the decreased risk in safety associated with handling concentrated alkali reagent solution of generally pH>8 such as caustic NaOH compared to handing solids.

Another advantage of these methods for treatment of marine exhaust gas is the reduction in weight for alkali storage on board of a sea-borne vessel because the weight of alkali reagent solids is much less than the weight and volume of a concentrated alkali reagent solution.

Yet another advantage of these methods for treatment of marine exhaust gas is the use of the washing water in the circulation loop of a wet scrubber in closed or hybrid configuration, so that freshwater is not required to be stored on board a sea-borne vessel.

An advantage of these methods for treatment of water or gas contaminated with SOₓ, organics, non-metals and/or metals is the use of water flow in the circulation loop hydraulically connected to an aqueous liquor or gas treatment unit, so that freshwater, cleaned or purified water is not required to make a slurry or solution of the fresh solid alkali reagent to supplement some of the alkali reagent which is spent and/or removed from the treatment unit (e.g., wet scrubber, a marine exhaust gas wet scrubber, blanket sludge reactor, fluidized bed reactor).

### BRIEF DESCRIPTION OF FIGURES

FIG. 1 illustrates a side-view diagram of a process for preparing a solution or slurry of a solid alkali reagent, comprising a pre-wetting step using one or more tangential aqueous slipstreams creating a swirling flow motion on an internal wall of a solid feeding chamber into which the solid alkali reagent is fed through a conduit and a mixing step using an educator which is hydraulically connected to the feeding chamber.

FIG. 2a illustrates a top-view diagram of the process shown in FIG. 1 wherein the solid feeding chamber comprises two liquid inlets through which liquid sidestreams flow tangentially downward forming a vortex towards the fluid outlet of the solid feed pre-wetting chamber.

FIG. 2b illustrates a top-view diagram of the process similar to FIG. 2a except that the solid feeding chamber comprises three liquid inlets through which liquid sidestreams flow tangentially downward forming a vortex towards the fluid outlet of the solid feed pre-wetting chamber.

FIG. 3 illustrates a side-view diagram of a liquid or a gas inlet in the form of a slanted open-ended pipe through which a liquid sidestream flows onto the internal wall of the solid feed pre-wetting chamber.

FIG. 4 illustrates a side-view diagram of a process for the removal of contaminants from a an aqueous liquid or a waste gas effluent wherein the solution or slurry of a solid alkali reagent is prepared according to the process illustrated in FIG. 1 and directed to a circulation closed loop connected to a treatment unit using part of a circulating liquor as the source of liquid for preparing the solution or slurry.

FIG. 5 illustrates a diagram of a lithium carbonate production process from brine.

### DEFINITIONS

Unless otherwise specified, all reference to percentage (%) herein refers to percent by weight.

“Fresh” material or sorbent denotes a material which has not been in contact with contaminants, whereas “spent” material denotes a material which has already been in contact with contaminants.

As used herein, the term “upstream” refers to a position situated in the opposite direction from that in which the fluid to be treated flows.

As used herein, the term “downstream” refers to a position situated in the same direction from that in which the fluid to be treated flows.

As used herein, the term “hydraulically connected” means connected through at least one pipe in which a fluid flows.

As used herein, the terms “% by weight”, “wt %”, “wt. %”, “weight percentage”, or “percentage by weight” are used interchangeably.

As used herein, the term “dry matter” refers to a material which has been subjected to drying at a temperature of 105° C. for at least 1 hour.

In the present specification, the choice of an element from a group of elements also explicitly describes:
the choice of two or the choice of several elements from the group,
the choice of an element from a subgroup of elements consisting of the group of elements from which one or more elements have been removed.

In the present specification, the description of a range of values for a variable, defined by a bottom limit, or a top limit, or by a bottom limit and a top limit, also comprises the embodiments in which the variable is chosen, respectively, within the value range: excluding the bottom limit, or excluding the top limit, or excluding the bottom limit and the top limit.

In the present specification, the description of several successive ranges of values for the same variable also comprises the description of embodiments where the variable is chosen in any other intermediate range included in the successive ranges. Thus, for example, when it is indicated that “the magnitude X is generally at least 10, advantageously at least 15”, the present description also describes the embodiment where: “the magnitude X is at least 11”, or also the embodiment where: “the magnitude X is at least 13.74”, etc.; 11 or 13.74 being values included between 10 and 15.

The term “comprising” includes “consisting essentially of” and also “consisting of”.

In the present specification, the use of “a” in the singular also comprises the plural (“some”), and vice versa, unless the context clearly indicates the contrary. By way of example, “a material” denotes one material or more than one material.

If the term “approximately” or “about” is used before a quantitative value, this corresponds to a variation of +10% of the nominal quantitative value, unless otherwise indicated.

### DETAILED DESCRIPTION OF PREFERRED EMBODIMENTS

The present invention relates to a method for the removal of at least one contaminant from an aqueous liquid or gas, comprising:

preparing a solution or slurry of a solid alkali reagent by
supplying a solid alkali reagent into a pre-wetting chamber via a solid feed pipe, preferably positioned at the top of this chamber;
supplying a liquid via two or more liquid sidestreams, each through a liquid inlet positioned on a side wall of the chamber to allow the liquid sidestreams to wash an internal wall of a frusto-conical section of the chamber and flow downward towards a fluid outlet of the chamber and to further wet the solid alkali reagent with the supplied liquid thereby forming a pre-wetted reagent, wherein the pre-wetted reagent exits the chamber via a fluid outlet which is connected to a conduit comprising an eductor;
flowing a stream though the conduit thereby creating a suction by the eductor to draw the pre-wetted reagent out of the solid feed pre-wetting chamber toward the chamber fluid outlet and mixing the pre-wetted reagent with the stream to form a slurry or solution of the alkali reagent exiting the eductor;
directing at least a portion of the slurry or solution of the alkali reagent exiting the eductor to a aqueous liquor or gas treatment unit, preferably via a circulation loop in fluid communication with the treatment unit, and

removing at least a portion of the contaminant from the aqueous liquor or gas in the treatment unit.

The method preferably comprises pre-wetting of the solid alkali reagent with a liquid and then mixing the pre-wetted reagent with liquid in an eductor to form the slurry or solution.

The pre-wetting step preferably comprises supplying the solid alkali reagent into a pre-wetting chamber, preferably through the top of this chamber via a solid feed pipe.

The pre-wetting step further comprises supplying a liquid via two or more liquid sidestreams, each through a liquid inlet disposed on a side wall of the chamber to allow the various liquid sidestreams to wash the internal wall of a frusto-conical section of the chamber and flow downward towards an fluid outlet of the chamber and further wetting the solid alkali reagent with the supplied liquid thereby forming a pre-wetted reagent. The pre-wetted reagent exits the chamber via a fluid outlet which is connected to a conduit comprising an eductor and through which a stream flows.

In operation the solid alkali reagent is generally conveyed through the solid feed pipe from a bulk pneumatic transport, bulk hopper car, storage bin or tank, sacks, big bags, feed hopper or other sources generally by air conveying, screw conveying, or other known techniques for moving dry particles through a pipe.

The mixing step preferably comprises flowing the stream into the conduit through the eductor creating a suction to draw the pre-wetted reagent out of the solid feed pre-wetting chamber toward the chamber fluid outlet into the eductor where the pre-wetted reagent is mixed with the stream to form a combined slurry or solution exiting the eductor.

In the method of the present invention, the treatment unit, can be a wet scrubber, preferably a marine exhaust gas wet scrubber, for removal of SOₓ, organics, non-metals and/or metals, or a wastewater mixed reactor (e.g., a blanket sludge reactor or fluidized bed reactor) for the removal of organics, non-metals and/or metals in the treatment unit.

In preferred embodiments, the liquid sidestreams flow tangentially to the internal wall of the chamber frusto-conical section in a downward spiraling manner, thereby forming a vortex towards the fluid outlet of the solid feed pre-wetting chamber.

In some embodiments, the liquid sidestreams entering the solid feed pre-wetting chamber have a flow rate about from 10 vol % to 30 vol % of the flow rate of the stream entering the conduit.

In some embodiments, the stream entering the conduit has a volumetric flow rate of from 9 to 10 m³/hr, and the liquid sidestreams entering the chamber have a combined volumetric flow rate of from 0.1 to 3 m³/hr, preferably from 1 to 2 m³/hr, more preferably from 1.2 to 1.6 m³/hr.

In preferred embodiments, the liquid flowing into the pre-wetting chamber is freshwater, seawater, or an aqueous solution/liquor.

In preferred embodiments, the stream flowing through the conduit comprises freshwater, seawater, or an aqueous solution/liquor.

In some embodiments, the liquid for pre-wetting the solid alkali reagent, the stream entering the conduit, or both originate from a wet scrubber, preferably a marine exhaust gas wet scrubber, operated in a close-loop or hybrid configuration. In such instance, the slurry or solution exiting the eductor is preferably directed to the wet scrubber.

In some embodiments, the liquid for pre-wetting the solid alkali reagent, the stream entering the conduit, or both originate from a blanket sludge reactor or a fluidized bed reactor. In such instance, the slurry or solution exiting the eductor is preferably directed to the reactor.

In some embodiments, the solid alkali reagent comprises a carbonate material, a bicarbonate material, a sesquicarbonate material, a calcium phosphate material, or combinations thereof, preferably comprises sodium carbonate, sodium bicarbonate, sodium sesquicarbonate, a material comprising hydroxyapatite and/or brushite, or combinations thereof.

In preferred embodiments, the alkali reagent is suitable for SOₓ removal from aqueous liquor or gas, and the solid alkali reagent comprises a carbonate material, a bicarbonate material, a sesquicarbonate material, or combinations thereof, preferably comprises sodium carbonate, sodium bicarbonate, sodium sesquicarbonate, or combinations thereof, more preferably comprises sodium carbonate, sodium bicarbonate, or combinations thereof.

In some embodiments, the alkali reagent is suitable for organics, non-metals and/or metals removal from aqueous liquor or gas, and the solid alkali reagent comprises a calcium phosphate material, preferably comprises a material comprising hydroxyapatite and/or brushite, more preferably comprises a calcium-deficient hydroxyapatite with a Ca/P ratio less than 1.67 and/or a hydroxyapatite composite comprising activated carbon and a hydroxyapatite, such as a calcium-deficient hydroxyapatite with a Ca/P ratio less than 1.67.

The method is preferably carried out in a system comprising:
a solid feed pre-wetting chamber comprising two or more liquid inlets, a frusto-conical section having an internal wall, a fluid outlet, and a central axis, wherein the frusto-conical section and the fluid outlet have the same central axis of the solid feed pre-wetting chamber;
a solid feed pipe, a portion of which being internal to the chamber and whose internal end has an axis aligned with the central axis of the solid feed pre-wetting chamber, and
a conduit comprising a liquid-driven eductor, said conduit being hydraulically connected to the frusto-conical section of the chamber via the fluid outlet of the frusto-conical section which is connected to a suction opening of the liquid-driven eductor.

In preferred embodiments, the conduit is hydraulically connected to a circulation loop of a treatment unit.

In preferred embodiments, the two or more liquid inlets comprise an open-ended pipe, preferably a slanted open-ended pipe which directs the liquid toward the internal wall. The open end of the pipe may be straight cut or preferably cut at an angle. In such instance, the open-ended pipe which serves as liquid inlet does not create mist or spray liquid droplets which may be directed towards the solid feed pipe and particularly a portion of said pipe which is internal to the chamber. The liquid preferably flows though the liquid inlets as a plurality of sidestreams directly, preferably on a tangential manner, along the internal wall of the frusto-conical section. The open-ended pipes are preferably fixed flushed to the wall of a cylindrical portion (or collar) of the pre-wetting chamber.

In preferred embodiments, the liquid inlets and the end of the solid feed pipe are horizontally displaced from each other, the liquid inlets being positioned downstream of the end of the solid fee pipe through which the solid reagent enters the chamber. In that manner, one can minimize exposure of the end of the solid feed pipe internal to the chamber with the liquid flowing through the liquid inlets.

In preferred embodiments, when the height of the collar is h₁, the end of the solid feed inlet pipe which is interior to the chamber may be positioned from ¼ to ½, preferably from ⅓ to ½, of the height h₁ of the collar from the top end of the chamber. In preferred embodiments, the end of the liquid inlets which is interior to the chamber may be positioned from ⅞ to 1, preferably from 15/16 to 1, of the height h₁ of the collar from the top end of the chamber.

At any rate, because formation of liquid droplets or mist may be unavoidable in the chamber, may migrate upwards and may deposit on the walls of the portion of the solid feed pipe interior to the chamber, the portion of the solid feed inlet pipe which is interior to the solid feed chamber may be coated with or constructed from a non-stick material having a low coefficient of friction such as polytetrafluoroethylene (e.g., Teflon PTFE).

In some embodiments, the two or more liquid inlets may include sprays or nozzles which direct the liquid entering the chamber toward the internal wall of the frusto-conical section of the chamber to spread the liquid evenly onto the surface of that internal wall. However these sprays or nozzles may create liquid droplets or mist which may move upwards towards the solid feed pipe portion which is internal to the chamber, thereby posing a potential risk of wetting the walls of the internal portion of this pipe. Such wetting may result in formation of solid deposits at or around the internal end of this pipe and thus potentially clogging the pipe and resulting in shutting down the operation if flow of solid feed is prevented.

In preferred embodiments, the two or more liquid inlets exclude sprays or nozzles to avoid for some of the liquid entering the chamber to be directed toward the solid feed pipe and avoid wetting the solid feed pipe portion which is internal to the chamber.

In preferred embodiments, the method is being carried out on board of a seaborne vessel which comprises the system and the treatment unit. In such embodiments, the treatment unit preferably comprises a wet scrubber, preferably a marine exhaust gas wet scrubber, operated in a close-loop or hybrid configuration, and in such instance, the treatment in the wet scrubber is also carried out on board of the seaborne vessel.

In fact when the wet scrubber, preferably the marine exhaust gas wet scrubber, has a hybrid configuration and is switched from an open loop operation to a close loop operation, the method for preparing the slurry or solution of the alkali reagent is initiated to supply the solution or slurry of the alkali reagent to the wet scrubber.

In some embodiments, the liquid for pre-wetting the solid alkali reagent, the stream entering the conduit, or both originate from a wet scrubber, preferably a marine exhaust gas wet scrubber, operated in a close-loop or hybrid configuration, preferably comprising a washing water recirculating to and from a wet scrubber. In such instance, the slurry or solution exiting the eductor is preferably directed to the wet scrubber via a recirculation loop through which the wet scrubber washing water circulates. In this manner, no freshwater is needed to make the solution or slurry of the alkali reagent.

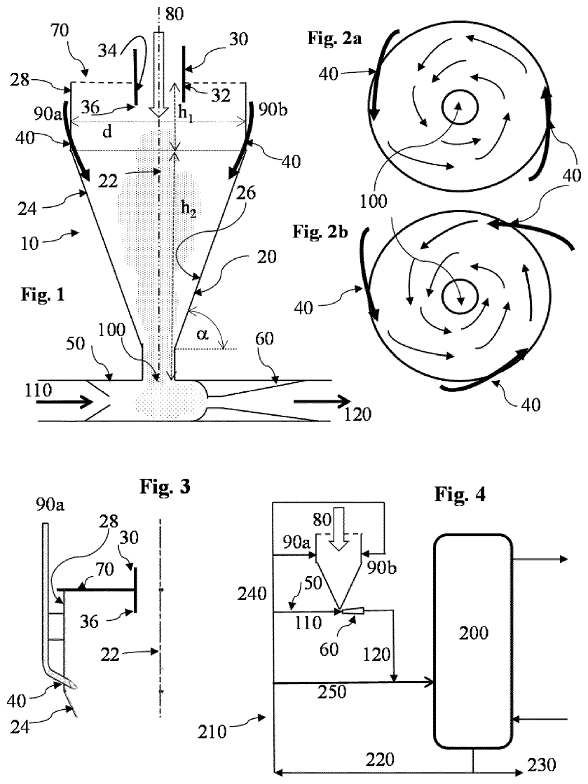

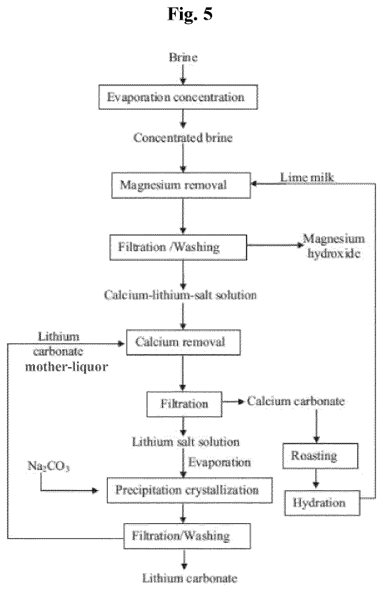

FIGS. 1, 2a, 2b, and 3 illustrate particular preferred embodiments of the present invention for preparing a slurry or solution from a solid alkali reagent.

FIG. 1 illustrates a side-view diagram of a system 10 for preparing a solution or slurry of a solid alkali reagent.

The system 10 comprises a solid feeding pre-wetting chamber 20 with a central axis 22, a conduit 50 which includes an eductor 60, and a solid inlet pipe 30 through which a solid alkali reagent 80 flows into the solid feeding pre-wetting chamber 20. The solid feeding pre-wetting chamber 20 comprises a frusto-conical section 24 and a cylindrical section 28, such that the walls of both sections are continuous. The cylindrical section 28 may also be called the collar 28 of the chamber. The chamber frusto-conical section 24 is positioned downstream of the cylindrical section 28 of the chamber with respect to the main direction of the solid flow in the chamber 20. The frusto-conical section 24 of the chamber 20 is hydraulically connected to the conduit 50 via a fluid outlet 100. The frusto-conical section 24 and the cylindrical section 28 preferably have the same common central axis 22. The common central axis 22 is preferably vertical.

The frusto-conical section 24 of the chamber 20 has an internal wall 26 slanted from the horizontal at an angle α. The angle α may be equal to or greater than the angle of repose of the solid alkali reagent. In preferred embodiments, the angle α is at least 50 degrees, preferably at least 55, more preferably at least 60 degrees and/or at most 78 degrees, preferably at most 75 degrees, more preferably at most 70 degrees.

The cylindrical section (or collar) 28 may be characterized by a vertical height h₁ and an internal diameter d. The frusto-conical section 24 can be characterized by a vertical height h₂. In some embodiments, the ratio “d/h₂” of the diameter d of the collar 28 to the height h₂ of the frusto-conical section 24 is from 1 to 1.5. In some embodiments, the ratio “h₂/h₁” of the height h₂ of the frusto-conical section 24 to the height h₁ of the collar 28 is from 1.3 to 3.5.

The frusto-conical section 24 is a conical section tapered downward toward the fluid outlet 100 of the chamber 20. There should not be any ledges or protruding elements on the interior wall 26 of the frusto-conical section 24 which would impede the movement of the pre-wetted reagent toward the fluid outlet 100 and which might promote plugging.

The solid feeding chamber 20 preferably comprises a lid 70 through which the solid inlet pipe 30 pierces.

The solid inlet pipe 30 may comprise a flexible conduit or a rigid conduit.

At the bottom of the frusto-conical section 24 of the solid feeding chamber 20, the fluid outlet 100 in fluid communication with the conduit 50 permits the solid alkali reagent 80 which has been pre-wetted by the liquid from sidestreams 90a and 90b to exit the solid feeding chamber 20. The direction of the fluid flow through the fluid outlet 100 is preferably perpendicular to the direction of fluid flow through the conduit 50 and the eductor 60.

The liquid sidestreams 90a and 90b preferably comprises aqueous sidestreams, preferably originating from a wet scrubber, preferably a marine exhaust gas wet scrubber, operated in a close-loop or hybrid configuration, preferably comprising at least portions of a washing water recirculating to and from a wet scrubber, preferably a marine exhaust gas wet scrubber.

The cylindrical section 28 of the solid feeding chamber 20 also comprises liquid inlets 40 piercing through the wall of the solid feeding chamber 20 and through which liquid streams 90a and 90b flow into the frusto-conical section 24 tangentially toward the internal wall 26 in a manner to cause the liquid to flow on the internal wall 26 of the frusto-conical section 24 and swirl around in a downward motion toward the bottom fluid outlet 100. This swirling action allows the wetting of the internal wall 26 and creation of a thin liquid film on top of the interior wall 26 of the chamber frusto-conical section 24 preventing solids from depositing onto that internal wall 26. The swirling action of the liquid in the chamber 20 along the internal wall 26 of the frusto-conical section 24 further allows for the pre-wetting of the alkali reagent solid in the chamber 20. The dissolution or dispersion of the solid starts with the liquid entering this frusto-conical section 24 of the solid feeding chamber 20 to form a pre-wetted reagent.

FIG. 2a illustrates a top view of the chamber 20 (when the lid 70 is removed) to show the swirling flow of liquid sidestreams from two side liquid inlets 40 on the wall 26 of the chamber frusto-conical section 24.

FIG. 2b illustrates a similar top view of the chamber 20 to show the swirling flow of liquid sidestreams from three side liquid inlets 40.

Referring back to FIG. 1, flowing a stream 110 into the conduit 50 through the eductor 60 creates a suction to draw the pre-wetted reagent out of the solid feed pre-wetting chamber 20 toward the chamber fluid outlet 100 into the eductor 60 where the pre-wetted reagent is combined with the stream 110 to form a combined slurry or solution 120 exiting the eductor 60.

The stream 110 preferably comprises an aqueous stream, preferably originating from a wet scrubber, preferably a marine exhaust gas wet scrubber, operated in a close-loop or hybrid configuration, preferably comprises at least a portion of a washing water recirculating to and from a wet scrubber, preferably a marine exhaust gas wet scrubber.

The combined slurry or solution 120 exiting the eductor 60 is preferably directed to a treatment unit, preferably via a circulation loop which is hydraulically connected to the treatment unit—this is not illustrated in FIG. 1 but is shown in FIG. 4.

In preferred embodiments, the portion 32 of the solid feed inlet pipe 30 which is interior to the solid feeding chamber 20 is not intentionally wetted with the liquid flowing though the liquid inlets 40, because it is difficult to prevent zones of stagnant liquid from forming on the solid feed inlet pipe 30. For example, if the inner wall 34 of the internal portion 32 of the solid feed inlet pipe 30 is wetted, the liquid would be relatively stagnant at the end 36 of the solid feed inlet pipe 30 and on the inner wall 34 of the solid feed inlet pipe 30 where capillary action would draw the liquid. When the liquid includes water, hydrated forms of the solid alkali reagent may accumulate in these stagnant zones forming crusty deposits on the inner wall 34 of the solid feed inlet pipe 30, which may very likely cause plugging.

In preferred embodiments, the end 36 of the solid feed inlet pipe 30 which is interior to the chamber 20 may be positioned from ¼ to ½, preferably from ⅓ to ½, of the height h₁ of the collar 28 from the top end of the chamber (which is represented by the dashed line 70 for the optional lid).

In preferred embodiments, the end of the liquid inlet 40 which is interior to the chamber 20 may be positioned from ⅞ to 1, preferably from 15/16 to 1, of the height h₁ of the collar 28 from the top end of the chamber (which is represented by the dashed line 70 for the optional lid).

In instances, the portion 32 of the solid feed inlet pipe 30 which is interior to the solid feed chamber 20 may, however, be unintentionally wetted by spray from the liquid inlets 40 of the chamber 20 and from the eductor 60. For this reason, the portion 32 of the solid feed inlet pipe 30 which is interior to the solid feed chamber 20 may be coated with or constructed from a non-stick material having a low coefficient of friction such as polytetrafluoroethylene (e.g., Teflon PTFE). The other portion of the solid inlet pipe 30 which is exterior to the solid feed chamber 20 may be constructed of a material chosen for strength (e.g., metal such as stainless steel) as this portion of the solid inlet pipe 30 is not susceptible to plug formation, or it can be made of the same material as the interior portion 32, generally for simplification of construction of the pipe 30. Thus, in preferred embodiments, the interior portion 32 of the solid feed inlet pipe 30 is preferably constructed from or coated with a material chosen for its low coefficient of friction, e.g. polytetrafluoroethylene.

In preferred embodiments, the two or more liquid inlets 40 comprise a slanted open-ended pipe which directs the liquid toward the internal wall 26 of the frusto-conical section 24.

See FIG. 3 which illustrates an example of such type of liquid inlet 40. In such instance, the open-ended pipe with a diagonal-cut end serves as liquid inlet 40 and it does not create mist or spray liquid droplets which may be directed towards the interior portion 32 and the end 36 of the solid feed pipe 30. The liquid preferably flows as a stream directly onto, preferably on a tangential manner, and along the internal wall 26 of the frusto-conical section 24.

In preferred embodiments, the two or more liquid inlets 40 are not affixed or piercing or mounted on top of the chamber such as through the lid 70 of the chamber 20.

Each of the two or more liquid inlets 40 (preferably comprising an open-ended pipe) is preferably fixed flushed to the wall of the cylindrical portion (collar) 28 of the chamber 20 which is positioned upstream of the frusto-conical section 24 of the chamber 20 with respect to the main direction of the liquid flow in the chamber 20. The advantage of positioning the two or more liquid inlets 40 through the wall of the cylindrical portion 28 of the chamber 20 is that there is a shorter distance for the liquid (compared to the situation if they were positioned through the lid 70 of the chamber) to make contact with the interior wall 26 of the chamber frusto-conical section 24.

In preferred embodiments, the two or more liquid inlets 40 exclude sprays or nozzles to avoid liquid droplets or mist to be directed toward the solid feed pipe 30 and avoid wetting the portion 32 of the solid feed pipe 30 which is internal to the chamber 20, including its end 36 and internal wall 34.

Referring back to FIG. 1, the pre-wetting of the fed solids 80 using one or more liquid sidestreams 90a, 90b which flow tangentially along the internal wall 26 of the frusto-conical section 24 allows for the solid alkali reagent to be fed through the conduit 50 without forming an encrusting deposit on the internal wall 26 of the chamber frusto-conical section 24 especially near the fluid outlet 100 and on the internal walls of the conduit 50 which are positioned downstream of the chamber outlet 100 and upstream of the eductor 60. Without the pre-wetting with the liquid sidestreams 90 (90a, 90b, . . . ) tangentially injected and directed onto the internal wall 26, crusty deposit formation may be observed near the fluid outlet 100, and in some instances can cause flow restriction and sometimes blockage of fluid flow the chamber fluid outlet 100 into the conduit 50.

The eductor 60 creates a strong suction in the conduit 50 such that the solid reagent 80 and the sidestreams 90a and 90b which form a pre-wetted reagent are sucked into the conduit 50 and mixed with the stream 110 which flows through the conduit 50. The pre-wetted reagent passes through the eductor 60 to be mixed with the stream 110 flowing through the conduit 50, in order to form a combined stream 120 in the eductor 60 and which exits the conduit 50.

This stream 120 may comprise a solution or slurry of the alkali reagent and has the combined flows of the stream 110 entering the conduit 50, of the supplied alkali reagent 80 and of the liquid sidestreams 90 (90a, 90b . . . ) used for pre-wetting the solid reagent 80.

The flow rate of the liquid sidestreams 90 (90a, 90b) entering the feeding chamber 20 is preferably about from 10 vol % to 30 vol % of the flow of the stream 110 entering the conduit 50 comprising the eductor 60.

As an example, the volumetric flow rate of the stream 110 entering the conduit 50 may be 9-10 m³/hr, whereas the combined volumetric flow rate of the sidestreams 90 entering the feeding chamber 20 may be from 0.1 to 3 m³/hr, preferably from 1 to 2 m³/hr, more preferably from 1.2 to 1.6 m³/hr.

FIG. 4 illustrates the method for removing at least one contaminant from an aqueous liquor or gas according to present invention. The slurry or solution of the alkali reagent is used in an aqueous liquor or gas treatment unit for removing contaminants and delivered to that unit via a circulation loop hydraulically connected to the treatment unit.

FIG. 4 illustrates a process flow diagram in which the system 10 of FIG. 1 is used. The system 10 for preparing the solution or slurry of the alkali reagent 80 is hydraulically connected to a treatment unit 200 via a circulation loop 210.

The treatment unit 200 may comprise a wet scrubber, particularly an exhaust gas scrubber, more particularly a marine exhaust gas scrubber.

The treatment unit 200 may comprise a blanket sludge reactor or a fluidized reactor.

In treatment unit 200, the alkali reagent removes at least a portion of contaminants from the aqueous liquor or gas; at least a portion of the aqueous liquor from the treatment unit 200 via stream 220 is withdrawn from the unit 200 and recirculated in the loop 210, while another portion of the aqueous liquor may be purged via stream 230 from unit 200.

The stream 220 withdrawn from the unit 200 is preferably split into a first portion via stream 110 flowing through the conduit 50; a second portion via stream 240 fed to the chamber 20 and the remainder portion 250 returned to the treatment unit 200. The stream 240 is preferably further split into the various tangential side streams 90a, 90b to enter the chamber 20 via tangential liquid inlets 40. If there are more than two tangential liquid inlets 40 in the chamber 20 (such as illustrated in FIG. 2b), then the stream 240 is preferably divided equally in the same number of sidestreams 90 as the number of liquid inlets 40.

The slurry or solution 120 exiting the eductor 60 is preferably combined with the stream 250 of the loop 210, preferably downstream of a pump which circulates the aqueous liquor in the loop 210.

The flow of stream 240 fed to the chamber 20 is preferably facilitated also by a pump preferably positioned upstream of the split between stream 110 and streams 90a, 90b.

In some embodiments, the treatment unit 200 is a wet scrubber, preferably a marine exhaust gas wet scrubber, in a close-loop or hybrid configuration.

When the wet scrubber 200 is operated in close loop, the circulation loop 210 permits the supplementation of fresh alkali reagent in solid form directly into the system 10 of FIG. 1 where the liquid for pre-wetting and dispersing/dissolving the solid alkali reagent in order to form the alkali reagent solution or slurry is at least a portion of the aqueous liquor originating from the wet scrubber.

Although not illustrated, the water stream 220 in the loop 210 exiting the scrubber 200 may be cleaned up prior to being fed to the system 10 via stream 110 and sidestreams 90. For example, solids may be removed from stream 220 prior to entering the system 10.

The volumetric flow rate of the aqueous sidestreams 90 entering the feeding chamber is preferably about from 10 vol % to 30 vol % of the volumetric flow of the water stream 110 entering the conduit 50 comprising the eductor 60.

The combined volumetric flow rate of the sidestreams 90 entering the feeding chamber and of the stream 110 entering the conduit 50 may represent a small fraction of the overall volumetric flow rate of the circulation loop 210. For example the combined volumetric flow rate of the streams (90 and 110) entering the system 10 may be from 1 vol % to 10 vol %, preferably from 1 vol % to 5 vol %, more preferably from 1.5 vol % to 3 vol %, of the volumetric flow rate of the stream 220 exiting the unit 200. As an example, the overall volumetric flow rate of the circulation loop 210 may be 500 m³/hr, whereas the combined volumetric flow rate of the stream entering the system 10 may be from 10 to 12 m³/hr.

In some embodiments, the treatment unit 200 is a wastewater treatment reactor which has the circulation loop 210 generally operated to maintain the solid alkali reagent in suspension (slurry form) inside the unit 200. The circulation loop 210 permits the supplementation of fresh solid alkali reagent directly into the system 10 of FIG. 1 where the liquid for making fresh slurry originates from the treatment unit 200.

A particular embodiment relates to a method for purifying a contaminated aqueous liquor containing organic contaminants, metallic contaminants and/or non-metallic contaminants, whether these metallic and/or non-metallic contaminants may be in the form of cations and/or anions, e.g., oxyanions.

Such method may comprise:

Mixing an alkali reagent in the contaminated aqueous liquor for a sufficient time of contact so that the alkali reagent adsorbs at least a portion of the contaminants; and subjecting the mixture to a separation to produce a treated aqueous liquor partially purified of contaminants and the ‘spent’ alkali reagent loaded with some contaminants that is removed from the mixture.

The mixing may be carried out in a sludge blanket contact reactor or in fluidized bed reactor.

The method may further comprise:

recovering a liquid overflow from the sludge blanket reactor;

adding a flocculant to the recovered liquid overflow of the sludge blanket reactor in order to form a mixture comprising particles of alkali reagent loaded with some contaminants and entrained out of the contact reactor and flocculated;

introducing said mixture into a settling tank where the mixture is separated into:
the aqueous liquor partially purified of contaminants, said partially purified aqueous liquor being recovered as overflow from the settling tank,
and into an underflow from the settling tank comprising flocculated and settled particles of alkali reagent recovered as underflow from the settling tank; and

recycling at least one portion of the underflow from the settling tank containing flocculated and settled particles of alkali reagent to the sludge blanket contact reactor.

In this particular embodiment, the slurry 120 of the alkali reagent is used to make-up the loss of reagent via small purging of spent alkali reagent and/or due to reduced trapping activity on the loaded alkali reagent.

In preferred embodiments, the alkali reagent is preferably mixed with the contaminated aqueous liquor in the unit 200 to achieve a weight concentration of at least 0.5% by weight, or at least 1% by weight, or at least 1.5% by weight, and at most 10% by weight, preferably at most 8% by weight, more preferably at most 6% by weight, yet more preferably at most 4% by weight.

In the unit 200, the contact time between the alkali reagent and the contaminated aqueous liquor may be at least 1 minute, preferably at least 15 minutes, more preferably at least 30 minutes.

The metallic contaminant to be removed may contain at least one metal selected from the group consisting of Al, Ag, Ba, Be, Ca, Ce, Co, Cd, Cu, Cr, Fe, Hg, La, Li, Mg, Mn, Mo, Ni, Pb, Pd, Rb, Sb, Sn, Th, Ti, U, V, Y, Zn; preferably contains at least Hg, more preferably in the form of cations. The non-metallic contaminant to be removed may contain at least one non-metal selected from the group consisting of As, B, and Se, preferably contains at least As and/or Se, more preferably in the form of oxyanions. The organic contaminants to be removed may be selected from the group consisting of VOC (volatile organic compound), aromatic compounds including PAHs (polycyclic aromatic hydrocarbons), dioxins, furans, phenolic compounds, or any mixture thereof.

### Alkali Reagent

In some embodiments of the present invention, the solid alkali reagent comprises a carbonate material, a bicarbonate material, a sesquicarbonate material, a calcium phosphate material, or combinations thereof, preferably comprises sodium carbonate, sodium bicarbonate, sodium sesquicarbonate, a material comprising hydroxyapatite and/or brushite, or combinations thereof.

According to preferred embodiments of the present invention, the solid alkali reagent comprises sodium bicarbonate, sodium carbonate, sodium sesquicarbonate, and/or a calcium phosphate material.

According to more preferred embodiments, the solid alkali reagent may comprise a (bi)carbonate material such as sodium bicarbonate, sodium carbonate, and/or sodium sesquicarbonate which is a double salt of sodium carbonate and bicarbonate.

In the present invention, the solid alkali reagent is preferably in form of particles.

As used herein, the term “equivalent spherical diameter” refers to the diameter of a sphere having the same equivalent volume as the particle. As used herein, particle average size may be expressed as “Dxx” where the “xx” is the volume percent of that particle having a size equal to or less than the Dxx. The D90 is defined as the particle size for which ninety percent by volume of the particles has a size lower than the D90. The D50 is defined as the particle size for which fifty percent by volume of the particles has a size lower than the D50. The D10 is defined as the particle size for which ten percent by volume of the particles has a size lower than the D10. For non spherical particles, the diameter is the equivalent spherical one.

The D10, D50 and D90 can be measured by laser diffraction analysis, for example on a Malvern type analyzer. Suitable Malvern systems include the Malvern MasterSizer S, Malvern 2000, Malvern 2600 and Malvern 3600 series. The particle size measurement can also be measured using laser diffraction, such as using a Beckman Coulter LS 230 laser diffraction particle size analyser (laser of wavelength 750 nm) on particles suspended in water and using a size distribution calculation based on Fraunhofer diffraction theory (particles greater than 10 μm) and on Mie scattering theory (particles less than 10 μm), the particles being considered to be spherical.

Specific surface area can be measured by laser light scattering using the nitrogen adsorption isotherm and the BET model (Brunauer, Emmett and Teller), such as with a Micromeritics Gemini 2360 Surface Area Analyzer.

As used herein “angle of repose” is the critical angle of repose as known in the art of a granular material, i.e. the steepest angle of descent or dip relative to the horizontal plate to which a material can be piled without slumping.

The procedure for the measurement of the angle of repose is preferably as follows. The angle of repose of the solid reagent can be measured after formation of a heaped cone that the solid reagent forms falling from a sieve size of 710μη on a cylinder of 50 mm diameter (D) and 80 mm in height. The height of the screen with respect to the apex of the cone should be maintained between 2 and 3 cm. AT slope angle (°) is calculated from the measurement of the height H (in mm) of the solid heap remaining on the cone:

[AT]=tan⁻¹(2H/D)*(180/π)

In preferred embodiment, the solid alkali reagent comprises at least 80% by weight of sodium carbonate, preferably at least 90% by weight of sodium carbonate, preferably at least 95% by weight of sodium carbonate, preferably at least 98% by weight of sodium carbonate, preferably at least 99% by weight of sodium carbonate, preferably at least 99.3% by weight of sodium carbonate, based on the total weight of the particles.

When the solid particles comprises dense soda ash particles, the dense soda ash particles preferably have a mean diameter D50 of which is greater than 100 μm, in general at least 120 μm, or even at least 140 μm, and/or preferably less than 1000 μm, or even less than 800 μm, or even less than 750 μm. In some preferred embodiments, the dense soda ash particles have a mean diameter D50 from 140 μm to 750 μm. In some preferred embodiments, the dense soda ash particles have a diameter D10 from 150 μm to 350 μm and/or a diameter D90 from 350 μm to 1100 μm.

When the solid particles comprises light soda ash particles, the light soda ash particles preferably have a mean diameter D50 of which is greater than 30 μm, in general at least 40 μm, and/or preferably less than 150 μm, or even less than 135 μm, or even less than 120 μm. In some preferred embodiments, the light soda ash particles have a mean diameter D50 from 40 μm to 120 μm. In some preferred embodiments, the light soda ash particles have a diameter D10 from 15 μm to 55 μm and/or a diameter D90 from 100 μm to 250 μm.

When the solid particles comprise dense soda ash particles, the dense soda ash particles preferably have an angle of repose of from 27 to 45.

When the solid particles comprise light soda ash particles, the light soda ash particles preferably have an angle of repose of from 50 to 65.

In some embodiment, the solid alkali reagent comprises at least 80% by weight of sodium bicarbonate, preferably at least 90% by weight of sodium bicarbonate, preferably at least 95% by weight of sodium bicarbonate, preferably at least 98% by weight of sodium bicarbonate, preferably at least 99% by weight of sodium bicarbonate, preferably at least 99.9% by weight of sodium bicarbonate, based on the total weight of the particles.

Examples of suitable sources of sodium bicarbonate for the solid alkali reagent include SOLVAir® Select 300 and 350 Sodium Bicarbonate from SOLVAY. The mean particle diameter D50 for SOLVAir® Select 300 and 350 Sodium Bicarbonate are about 140 μm and 15 μm, respectively.

When the solid particles comprises sodium bicarbonate, the sodium bicarbonate particles preferably have a mean diameter D50 of which is at least 10 μm, in general at least 12 μm, and/or preferably at most 200 μm, or even at most 150 μm. In some preferred embodiments, the sodium bicarbonate particles have a mean diameter D50 from 10 μm to 35 μm. In some preferred embodiments, the sodium bicarbonate particles have a diameter D10 from 1 μm to 20 μm and/or a diameter D90 from 50 μm to 300 μm.

In an embodiment, the solid alkali reagent comprises a sesquicarbonate, preferably sodium sesquicarbonate. Preferably, the alkali reagent comprises sodium sesquicarbonate dihydrate (Na₂CO₃.NaHCO₃.2H₂O). The sodium sesquicarbonate can have different origins. It can be produced artificially out of different sodium sources. However, it is particularly interesting that sesquicarbonate derives from a natural trona ore. Suitable sodium sesquicarbonate can have a mean particle diameter D50 from 0.1 to 10 mm (100-10,000 μm). However sodium sesquicarbonate is preferably milled to reduce the average particle size prior to use in the preparation method according to the first aspect of the invention. Examples of suitable sources of sodium sesquicarbonate for the solid alkali reagent include SOLVAir® Select 200 and 150 Trona from SOLVAY. The mean particle diameter D50 for SOLVAir® Select 200 Trona is about from 25 to 50 μm, preferably from 35 to 46 μm. The SOLVAir® Select 150 Trona has a D50 less than that of the SOLVAir® Select 200 Trona.

In preferred embodiments of the present invention, the solid alkali reagent may comprise, based on the total weight of dry matter:
at least 95 wt % Na₂CO₃, preferably at least 97 wt % Na₂CO₃, more preferably at least 99 wt % Na₂CO₃, or
at least 95 wt % NaHCO₃, preferably at least 97 wt % NaHCO₃, or
at least 70 wt % sesquicarbonate (Na₂CO₃.NaHCO₃.2H₂O), preferably at least 80 wt % Na₂CO₃.NaHCO₃.2H₂O.

In preferred embodiments of the present invention, the method provides a solution of an alkali reagent which is suitable for SOₓ removal from aqueous liquor or gas. In such instance, the solution preferably comprises a carbonate salt, a bicarbonate salt, or combinations thereof, more preferably comprises sodium carbonate, sodium bicarbonate, or combinations thereof. In such embodiments, the solution preferably comprises at least 1 wt % of the alkali reagent, or at least 3 wt %, or at least 5 wt % and/or preferably at most 20 wt %, or at most 15 wt %, or at most 10 wt % of the alkali reagent.

According to alternate preferred embodiments in the present invention, the solid alkali reagent may comprise a water-insoluble material such as a calcium phosphate material.

The solid alkali reagent may comprise an apatite and/or a brushite (dicalcium phosphate dihydrate).

The solid alkali reagent preferably comprises an apatite, more preferably a hydroxyapatite (HAP) having the chemical formula:

Ca₁₀₋ₓ(HPO₄)ₓ(PO₄)₆₋ₓ(OH)₂₋ₓ, where 0≤x≤1.

Hydroxyapatite is an adsorbent which can be used for trapping and immobilizing metals, non-metals, and organics within its structure from contaminated effluents, particularly aqueous effluents. See, for example, WO 2015/173437 by Solvay SA.

The metallic contaminant to be removed may contain at least one metal selected from the group consisting of Al, Ag, Ba, Be, Ca, Ce, Co, Cd, Cu, Cr, Fe, Hg, La, Li, Mg, Mn, Mo, Ni, Pb, Pd, Rb, Sb, Sn, Th, Ti, U, V, Y, Zn; preferably contains at least Hg, more preferably in the form of cations. The non-metallic contaminant to be removed may contain at least one non-metal selected from the group consisting of As, B, and Se, preferably contains at least As and/or Se, more preferably in the form of oxyanions. The organic contaminants to be removed may be selected from the group consisting of VOC (volatile organic compound), aromatic compounds including PAHs (polycyclic aromatic hydrocarbons), dioxins, furans, phenolic compounds, or any mixture thereof

Hydroxyapatite should not be confused with tricalcium phosphate (TCP), which has a similar weight composition: Ca₃(PO₄)₂. The Ca/P molar ratio of TCP is 1.5 whereas the Ca/P ratio is more than 1.5 for hydroxyapatite. Industrial apatites sold as food additives or mineral fillers are, as a general rule, variable mixtures of TCP and hydroxyapatite.

The hydroxyapatite may be a stoichiometric hydroxyapatite with a Ca/P molar ratio of 1.67 or hydroxyapatite deficient in calcium with a Ca/P molar ratio more than 1.5 and less than 1.67, more preferably with a Ca/P molar ratio more than 1.54 and less than 1.65.

The solid alkali reagent preferably comprises a synthetic hydroxyapatite. A suitable example of such synthetic hydroxyapatite is described in US2017/0080401 by SOLVAY SA.

In some embodiments, the hydroxyapatite in the solid alkali reagent may be a synthetic hydroxyapatite composite wherein at least one additive is incorporated or embedded into the hydroxyapatite. In such instance, the at least one additive comprises a metal (zero-valent metal) or any derivatives thereof (such as hydroxide, oxyhydroxide, oxide), and/or at least one activated carbon. The metal additive may include iron or aluminium.

In some embodiments, the solid alkali reagent may further comprise another calcium compound other than hydroxyapatite.

In preferred embodiments, the solid alkali reagent preferably comprises calcium carbonate and a hydroxyapatite, preferably a calcium-deficient hydroxyapatite with a Ca/P greater than 1.5 and less than 1.67. In such instances, the solid alkali reagent is synthetically made.

In some embodiments, the solid alkali reagent may comprise, based on the total weight of dry matter:
at least 70 wt %, advantageously at least 75 wt %, and more advantageously still at least 80 wt % of hydroxyapatite, preferably a calcium-deficient hydroxyapatite with a Ca/P greater than 1.5 and less than 1.67; and
at most 98 wt %, advantageously at most 97 wt % of hydroxyapatite, preferably a calcium-deficient hydroxyapatite with a Ca/P greater than 1.5 and less than 1.67.

In such embodiments, the solid alkali reagent may comprise, based on the total weight of dry matter:
at most 20 wt % calcium carbonate, advantageously at most 15 wt % calcium carbonate, more advantageously at most 10 wt % calcium carbonate; and
at least 0.5 wt % calcium carbonate, advantageously at least 1% calcium carbonate, more advantageously at least 2% calcium carbonate.

In alternate embodiments, the solid alkali reagent may comprise, based on the total weight of dry matter:
at most 85 wt %, advantageously at most 70 wt %, and more advantageously still at most 65 wt % of a hydroxyapatite, preferably a calcium-deficient hydroxyapatite with a Ca/P greater than 1.5 and less than 1.67; and
at least 25 wt %, advantageously at least 30 wt % of a hydroxyapatite, preferably a calcium-deficient hydroxyapatite with a Ca/P greater than 1.5 and less than 1.67.

In such embodiments, the solid alkali reagent may comprise, based on the total weight of dry matter:
more than 7 wt % calcium carbonate, advantageously more than 10 wt % calcium carbonate, more advantageously more than 20 wt % calcium carbonate, yet more advantageously at least 25 wt % calcium carbonate; and
at most 75 wt % calcium carbonate, advantageously at most 70% calcium carbonate.

In some embodiments, the solid alkali reagent may further include from 1 to 40 wt % activated carbon, preferably from 2 to 30 wt % activated carbon, more preferably from 3 to 20 wt % activated carbon, yet more preferably from 5 to 15 wt % activated carbon.

In preferred embodiments, the solid alkali reagent comprises a calcium phosphate material such as hydroxyapatite, in the form of particles.

In some embodiments, the particles of the calcium phosphate material preferably have a BET specific surface area of at least 60 m²/g, preferably of at least 90 m²/g, more preferably of at least 100 m²/g, yet more preferably of at least 110 m²/g, most preferably of at least 120 m²/g. In some embodiments, the particles of the calcium phosphate material have a BET specific surface area of at most 200 m²/g, preferably of at most 185 m²/g, preferably of at most 170 m²g.

The solid particles of the calcium phosphate material preferably have a mean diameter D50 of which is greater than 10 μm, in general at least 20 μm, or even at least 25 μm, or even at least 30 μm, or even at least 35 μm, and/or preferably less than 1000 μm, or even less than 800 μm, or even less than 500 μm. In some preferred embodiments, the solid particles of the calcium phosphate material have a mean diameter D50 from 20 microns to 60 microns. The mean particles size D50 is the diameter such that 50% by weight of the particles have a diameter less than said value. The particle size measurement may be measured using laser diffraction, such as using a Beckman Coulter LS 230 laser diffraction particle size analyser (laser of wavelength 750 nm) on particles suspended in water and using a size distribution calculation based on Fraunhofer diffraction theory (particles greater than 10 μm) and on Mie scattering theory (particles less than 10 μm), the particles being considered to be spherical.

In preferred embodiments of the present invention, the method provides a slurry of the alkali reagent which is suitable for organics, non-metals and/or metals removal from an aqueous liquor. In such instance, the slurry preferably comprises a water-insoluble calcium phosphate material, preferably a material comprising hydroxyapatite and/or brushite, more preferably a material comprising a calcium-deficient hydroxyapatite with a Ca/P ratio less than 1.67 and/or a synthetic hydroxyapatite composite comprising activated carbon and a hydroxyapatite, such as a calcium-deficient hydroxyapatite with a Ca/P ratio less than 1.67.

In such embodiments, the slurry of the alkali reagent which is made in the preparation method preferably comprises at least 0.5 wt % of solids, or at least 1 wt % of solids, or at least 2 wt % of solids, or at least 5 wt % of solids, and/or preferably at most 25 wt % of solids, or at most 20 wt % of solids, or at most 15 wt % of solids.

In some embodiments in of the present invention, the method provides a slurry of one or more alkali reagents which is/are suitable for SOₓ, organics, non-metals and/or metals removal from an aqueous liquor. In such instance, the slurry may comprise a water-insoluble calcium phosphate material dispersed in a solution of a (bi)carbonate salt. The water-insoluble calcium phosphate material in the slurry is preferably a material comprising hydroxyapatite and/or brushite, more preferably a material comprising a calcium-deficient hydroxyapatite with a Ca/P ratio less than 1.67 and/or a hydroxyapatite composite comprising activated carbon and a hydroxyapatite, such as a calcium-deficient hydroxyapatite with a Ca/P ratio less than 1.67. The solution of a (bi)carbonate salt preferably comprises sodium carbonate, sodium bicarbonate, or combinations thereof, more preferably comprises sodium carbonate. In such embodiments, the slurry of the alkali reagent preferably comprises at least 0.5 wt % of solids, or at least 1 wt % of solids, or at least 2 wt % of solids, or at least 5 wt % of solids, and/or preferably at most 25 wt % of solids, or at most 20 wt % of solids, or at most 15 wt % of solids.

In particular the present invention relates to the following embodiments:

ITEM 1. A method for the removal of at least one contaminant from an aqueous liquor or a gas, comprising:

preparing a solution or slurry of a solid alkali reagent by,
supplying a solid alkali reagent into a pre-wetting chamber via a solid feed pipe, preferably positioned at the top of this chamber;
supplying a liquid via two or more liquid sidestreams, each through a liquid inlet positioned on a side wall of the chamber to allow the liquid sidestreams to wash an internal wall of a frusto-conical section of the chamber and flow downward towards a fluid outlet of the chamber and to further wet the solid alkali reagent with the supplied liquid thereby forming a pre-wetted reagent, wherein the pre-wetted reagent exits the chamber via a fluid outlet which is connected to a conduit comprising an eductor;
flowing a stream though the conduit thereby creating a suction by the eductor to draw the pre-wetted reagent out of the solid feed pre-wetting chamber toward the chamber fluid outlet and mixing the pre-wetted reagent with the stream to form a slurry or solution of the alkali reagent exiting the eductor;
   directing at least a portion of the slurry or solution of the alkali reagent exiting the eductor to a treatment unit, preferably via a circulation loop in fluid communication with the treatment unit, and
   removing at least a portion of the contaminant from the aqueous liquor or gas in the treatment unit.

ITEM 2. The method according to ITEM 1, in which the solid alkali reagent comprises a carbonate material, a bicarbonate material, a sesquicarbonate material, a calcium phosphate material, or combinations thereof, preferably comprises sodium carbonate, sodium bicarbonate, sodium sesquicarbonate, a material comprising hydroxyapatite and/or brushite, or combinations thereof.

ITEM 3. The method according to ITEM 1 or 2, in which the alkali reagent is suitable for SOx removal from water or gas, and in which the solid alkali reagent comprises a carbonate material, a bicarbonate material, a sesquicarbonate material, or combinations thereof, preferably comprises sodium carbonate, sodium bicarbonate, sodium sesquicarbonate, or combinations thereof.

ITEM 4. The method according to any of ITEMS 1, 2, or 3, in which the alkali reagent is suitable for organics, non-metals and/or metals removal from aqueous liquor or gas, and in which the solid alkali reagent comprises a calcium phosphate material, preferably comprises a material comprising hydroxyapatite and/or brushite, more preferably comprises a calcium-deficient hydroxyapatite with a Ca/P ratio less than 1.67 and/or a hydroxyapatite composite comprising activated carbon and a hydroxyapatite, such as a calcium-deficient hydroxyapatite with a Ca/P ratio less than 1.67.

ITEM 5. The method according to any of the preceding ITEMS, in which the treatment unit comprises a wet scrubber, preferably a marine exhaust gas wet scrubber, operated in a close-loop or hybrid configuration.

ITEM 6. The method according to any of the preceding ITEMS, in which the liquid flowing into the pre-wetting chamber, or the stream flowing through the conduit, or both comprise(s) freshwater, seawater, or an aqueous solution.

ITEM 7. The method according to any of the preceding ITEMS, being carried out on board of a seaborne vessel.

ITEM 8. The method according to any of the preceding ITEMS, in which the liquid for pre-wetting the solid alkali reagent, the stream entering the conduit, or both originate from a wet scrubber, preferably a marine exhaust gas wet scrubber, operated in a close-loop or hybrid configuration, preferably comprises at least part of a washing water recirculating to and from a wet scrubber operated in a close-loop or hybrid configuration, and in which the slurry or solution exiting the eductor is directed to the wet scrubber.

ITEM 9. The method according to any of ITEMS 1-7, in which the liquid for pre-wetting the solid alkali reagent, the stream entering the conduit, or both originate from a sludge blanket contact reactor or a fluidized bed reactor, preferably comprises at least part of a liquor recirculating to and from the reactor, and in which the slurry exiting the eductor is directed to the reactor.

ITEM 10. The method according to any of the preceding ITEMS, in which the liquid sidestreams entering the solid feed pre-wetting chamber have a flow rate about from 10 vol % to 30 vol % of the flow rate of the stream entering the conduit.

ITEM 11. The method according to any of the preceding ITEMS, in which the stream entering the conduit has a volumetric flow rate of from 9 to 10 m³/hr, and in which the liquid sidestreams entering the chamber have a combined volumetric flow rate of from 0.1 to 3 m³/hr, preferably from 1 to 2 m³/hr, more preferably from 1.2 to 1.6 m³/hr.

ITEM 12. The method according to any of the preceding ITEMS, being carried out in a system comprising:
a solid feed pre-wetting chamber comprising two or more liquid inlets, a frusto-conical section having an internal wall, a fluid outlet, and a central axis, wherein the frusto-conical section and the fluid outlet have the same central axis of the solid feed pre-wetting chamber;
a solid feed pipe, a portion of which being internal to the chamber and whose internal end has an axis aligned with the central axis of the solid feed pre-wetting chamber, and
a conduit comprising a liquid-driven eductor, said conduit being hydraulically connected to the frusto-conical section of the chamber via the fluid outlet of the chamber which is connected to a suction opening of the liquid-driven eductor, said conduit being hydraulically connected to the circulation loop of an aqueous liquor or gas treatment unit, such as a wet scrubber, a marine exhaust gas wet scrubber, or a slurry water treatment reactor.

ITEM 13. The method according to any of the preceding ITEMS, in which the chamber further comprises a collar, and in which the chamber frusto-conical section is positioned downstream of the collar of the chamber with respect to the main direction of the solid flow in the chamber.

ITEM 14. The method according to ITEM 13, in which the height of the collar is h₁, and in which the end of the solid feed inlet pipe which is interior to the chamber may be positioned from ¼ to ½, preferably from ⅓ to ½, of the height h₁ of the collar from the top end of the chamber.

ITEM 15. The method according to ITEM 13 or 14, in which the height of the collar is h₁, and in which the end of the liquid inlets which is interior to the chamber may be positioned from ⅞ to 1, preferably from 15/16 to 1, of the height h₁ of the collar from the top end of the chamber.

ITEM 16. The method according to any of the ITEMS 13-15, in which open-ended pipes are preferably fixed flushed to the wall of collar of the pre-wetting chamber.

ITEM 17. The method according to any of the ITEMS 13-16, in which the chamber collar is characterized by an internal diameter d, in which the chamber frusto-conical section 24 is characterized by a vertical height h₂, and in which the ratio “d/h₂” of the diameter d of the chamber collar to the height h₂ of the chamber frusto-conical section 24 is from 1 to 1.5.

ITEM 18. The method according to any of the ITEMS 13-17, in which the chamber collar is characterized by a vertical height h₁, and in which the ratio “h₂/h₁” of the height h₂ of the chamber frusto-conical section to the height h₁ of the chamber collar is from 1.3 to 3.5.

ITEM 19. The method according to any of the preceding ITEMS, in which the two or more liquid inlets comprise an open-ended pipe, preferably a slanted open-ended pipe, which directs the liquid toward the internal wall of the chamber frusto-conical section.

ITEM 20. The method according to any of the preceding ITEMS, in which the two or more liquid inlets exclude sprays or nozzles to avoid liquid to be directed toward the solid feed pipe and avoid wetting a portion of the solid feed pipe portion which is internal to the pre-wetting chamber.

ITEM 21. The method according to any of the preceding ITEMS, in which the liquid sidestreams flow tangentially onto an internal wall of the chamber frusto-conical section in a downward spiraling manner, thereby forming a vortex towards the fluid outlet of the pre-wetting chamber.

ITEM 22. A method according to any of the preceding ITEMS, in which the gas originates from an exhaust gas, particularly originate from a marine engine exhaust gas.

ITEM 23. A method according to any of the preceding ITEMS, in which the contaminant comprises SOₓ, organics, non-metals and/or metals.

### EXAMPLES

The examples, the description of which follows, serve to illustrate the invention.

### Example 1

A unit as illustrated by FIG. 1 was used for this test.

A dense soda ash solution was made using this equipment at various temperatures: 20, 30, 40 and 50° C. using a solid flow rate of 1000 kg/hr of dense soda ash, 9.4-9.8 m³/hr of flow rate of water in the conduit containing the eductor and 1.2-1.6 m³/hr of water (liquid) divided into two sidestreams of equal flow rate tangentially flowing onto the interior wall of the frusto-conical section of the pre-wetting chamber. Under these operation conditions no issue of clogging or crust formation was observed on the internal surfaces of the solid feed pipe and there was no clogging of the fluid outlet at the bottom of the chamber or in the eductor.

1. A method for the removal of at least one contaminant from an aqueous liquor or a gas, comprising:
preparing a solution or slurry of a solid alkali reagent by supplying a solid alkali reagent into a pre-wetting chamber via a solid feed pipe;
supplying a liquid via two or more liquid sidestreams, each through a liquid inlet positioned on a side wall of the chamber to allow the liquid sidestreams to wash an internal wall of a frusto-conical section of the chamber and flow downward towards a fluid outlet of the chamber and to further wet the solid alkali reagent with the supplied liquid thereby forming a pre-wetted reagent, wherein the pre-wetted reagent exits the chamber via a fluid outlet which is connected to a conduit comprising an eductor;
flowing a stream though the conduit thereby creating a suction by the eductor to draw the pre-wetted reagent out of the solid feed pre-wetting chamber toward the chamber fluid outlet and mixing the pre-wetted reagent with the stream to form a slurry or solution of the alkali reagent exiting the eductor;
directing at least a portion of the slurry or solution of the alkali reagent exiting the eductor to an aqueous liquor or gas treatment unit, and
removing at least a portion of the contaminant from the aqueous liquor or gas in the treatment unit.

2. The method according to claim 1, in which the solid alkali reagent comprises a carbonate material, a bicarbonate material, a sesquicarbonate material, a calcium phosphate material, or combinations thereof.

3. The method according to claim 1, in which the alkali reagent is suitable for SOₓ removal from water, and in which the solid alkali reagent comprises a carbonate material, a bicarbonate material, a sesquicarbonate material, or combinations thereof.

4. The method according to claim 1, in which the alkali reagent is suitable for organics, non-metals and/or metals removal from aqueous liquor, and in which the solid alkali reagent comprises a calcium phosphate material.

5. The method according to a claim 1, in which the treatment unit comprises a wet scrubber, preferably a marine exhaust gas wet scrubber, operated in a close-loop or hybrid configuration.

6. The method according to claim 1, in which the liquid flowing into the pre-wetting chamber, or the stream flowing through the conduit, or both comprise(s) freshwater, seawater, or an aqueous solution.

7. The method according to claim 1, being carried out on board of a seaborne vessel.

8. The method according to claim 1, in which the liquid for pre-wetting the solid alkali reagent, the stream entering the conduit, or both originate from a wet scrubber, operated in a close-loop or hybrid configuration, operated in a close-loop or hybrid configuration, and in which the slurry or solution exiting the eductor is directed to the wet scrubber.

9. The method according to claim 1, in which the liquid for pre-wetting the solid alkali reagent, the stream entering the conduit, or both originate from a sludge blanket contact reactor or a fluidized bed reactor, and in which the slurry exiting the eductor is directed to the reactor.

10. The method according to claim 1, in which the liquid sidestreams entering the solid feed pre-wetting chamber have a flow rate about from 10 vol % to 30 vol % of the flow rate of the stream entering the conduit.

11. The method according to claim 1, being carried out in a system comprising:
a solid feed pre-wetting chamber comprising two or more liquid inlets, a frusto-conical section having an internal wall, a fluid outlet, and a central axis, wherein the frusto-conical section and the fluid outlet have the same central axis of the solid feed pre-wetting chamber;
a solid feed pipe, a portion of which being internal to the chamber and whose internal end has an axis aligned with the central axis of the solid feed pre-wetting chamber, and
a conduit comprising a liquid-driven eductor, said conduit being hydraulically connected to the frusto-conical section of the chamber via the fluid outlet of the chamber which is connected to a suction opening of the liquid-driven eductor, said conduit being hydraulically connected to the circulation loop of a treatment unit.

12. The method according to claim 1, in which the two or more liquid inlets comprise an open-ended pipe, which directs the liquid toward the internal wall of the chamber frusto-conical section.

13. The method according to claim 1, in which the two or more liquid inlets exclude sprays or nozzles to avoid liquid to be directed toward the solid feed pipe and avoid wetting a portion of the solid feed pipe portion which is internal to the pre-wetting chamber.

14. The method according to claim 1, in which the liquid sidestreams flow tangentially onto an internal wall of the chamber frusto-conical section in a downward spiraling manner, thereby forming a vortex towards the fluid outlet of the pre-wetting chamber.

15. The method of claim 1 in which the gas originates from an exhaust gas.

16. The method of claim 1, in which the at least one contaminant comprises SOₓ, organics, non-metals and/or metals.

17. The method of claim 1, in which the gas originates from a marine engine exhaust gas.

18. The method of claim 1, in which directing at least a portion of the slurry or solution of the alkali reagent exiting the eductor to the aqueous liquor or gas treatment unit is carried out via a circulation loop in fluid communication with the treatment unit.
